(19) United States
(12) Patent Application Publication
(10) Pub. No.: US 2026/0214561 A1
(43) Pub. Date: Jul. 23, 2026

(54) NETWORK CONDITION BASED NETWORK SLICE SERVICE IN WIRELESS COMMUNICATION NETWORKS

(71) Applicant: T-MOBILE INNOVATIONS LLC, Overland Park, KS (US)

(72) Inventor: Wafik Abdelshahid, Kenmore, WA (US)

(21) Appl. No.: 19/035,175

(22) Filed: Jan. 23, 2025

Related U.S. Application Data
(60) Provisional application No. 63/746,427, filed on Jan. 17, 2025.

(51) Int. Cl. H04W 48/18; H04W 24/10; H04W 48/16

(52) U.S. Cl. CPC H04W 48/18; H04W 24/10; H04W 48/16

(57) ABSTRACT

Various embodiments include a system that comprises processing circuitry in an access node. The processing circuitry receives a measurement report from a user device that characterizes a user device session requirement and an access node radio condition. The processing circuitry determines a throughput requirement for a session of the user device based on the user device session requirement and the access node radio condition. The processing circuitry selects one or more network slice features of the network slice that the user device is assigned to based on the throughput requirement and an access node capacity. The processing circuitry enables the one or more selected network slice features for the session of the user device. The processing circuitry exchanges user data with the user device via the network slice using the one or more enabled network slice features for the session.

### CROSS-REFERENCE TO RELATED APPLICATIONS

This U.S. Patent Application claims the benefit of and priority to U.S. Provisional Patent Application 63/746,427 titled, “NETWORK CONDITION BASED NETWORK SLICE SERVICE IN WIRELESS COMMUNICATION NETWORKS” which was filed on January 17^{th}, 2025. U.S. Provisional Patent Application 63/746,427 is hereby incorporated by reference in its entirety into this U.S. Patent Application.

### TECHNICAL FIELD

Various embodiments of the present technology relate to network slicing, and more specifically, to selectively enabling network slice features for a user device based on network conditions.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Wireless communication networks implement network slicing to serve wireless user devices. A network slice is a type of network partition that groups a set of RAN and core network resources that have capabilities to provide one or more service types. Network slices may be configured to provide low-latency services, media streaming services, Internet-of-Things (IoT) services, and the like. Network slices comprise features like maximum allowed latency, Guaranteed Bit Rate (GBR), Quality-of-Service (QoS) level, dedicated bandwidth, priority scheduling, and/or other features to support the one or more service types. Exemplary slice types include Ultra-Reliable Low Latency Communication (URLLC), Enhanced Mobile Broadband (eMBB), Massive Machine Type Communications (mMTC), Vehicle-to-Everything (V2X), Fixed Wireless Access (FWA), and private. By implementing network slicing, wireless communication networks optimize the computing and radio resources for specific service types thereby enhancing the overall user experience.

When a user device attaches to a core network over a RAN, the user device registers for service with the core network. To register the user device, the core network accesses a subscriber profile associated with the user device that indicates the services that the user device is authorized to receive. The core network assigns the user device to one or more network slices based on the user device’s authorized services. Some network slice features are computationally intensive to implement and/or consume a disproportionate amount of radio resources when compared to default (e.g., best effort) service. Moreover, some wireless communication networks do not consider network conditions when assigning user devices to network slices. For example, when network conditions are optimal (e.g., the RAN is lightly loaded, the required session throughput is low, etc.), the wireless communication network may be able meet the session requirements of the user device without implementing the slice features of the network slice the user device is assigned to. Implementing computationally and/or resource intensive slice features when they are not needed constitutes an inefficient allocation of network resources.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for network slicing. Some embodiments comprise a method. The method comprises receiving a measurement report from a user device that characterizes a user device session requirement and an access node radio condition. The method further comprises determining a throughput requirement for a session of the user device based on the user device session requirement and the access node radio condition. The method further comprises selecting one or more network slice features of the network slice that the user device is assigned to based on the throughput requirement and an access node capacity. The method further comprises enabling the one or more selected network slice features for the session of the user device. The method further comprises exchanging user data with the user device via the network slice using the one or more enabled network slice features for the session.

Some embodiments comprise a system. The system comprises processing circuitry in an access node. The processing circuitry receives a measurement report from a user device that characterizes a user device session requirement and an access node radio condition. The processing circuitry determines a throughput requirement for a session of the user device based on the user device session requirement and the access node radio condition. The processing circuitry selects one or more network slice features of the network slice that the user device is assigned to based on the throughput requirement and an access node capacity. The processing circuitry enables the one or more selected network slice features for the session of the user device. The processing circuitry exchanges user data with the user device via the network slice using the one or more enabled network slice features for the session.

Some embodiments comprise one or more non-transitory computer readable storage media having program instructions stored thereon. When executed by a computing system, the program instructions direct the computing system to perform operations. The operations comprise receiving a measurement report from a user device that characterizes a user device session requirement and an access node radio condition. The operations further comprise determining a throughput requirement for a session of the user device based on the user device session requirement and the access node radio condition. The operations further comprise selecting one or more network slice features of the network slice that the user device is assigned to based on the throughput requirement and an access node capacity. The operations further comprise enabling the one or more selected network slice features for the session of the user device. The operations further comprise exchanging user data with the user device via the network slice using the one or more enabled network slice features for the session.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of a communication network to selectively enable network slice features.

FIG. 2 illustrates an exemplary operation of the communication network to selectively enable network slice features.

FIG. 3 illustrates another exemplary operation of the communication network to selectively enable network slice features.

FIG. 4 illustrates an example of an access node in the communication network that selectively enables network slice features.

FIG. 5 illustrates an example of a Fifth Generation (5G) communication network to selectively enable network slice features.

FIG. 6 illustrates an example of a 5G User Equipment (UE) in the 5G communication network that selectively enables network slice features.

FIG. 7 illustrates an example of a 5G gNodeB in the 5G communication network that selectively enables network slice features.

FIG. 8 illustrates an example of a 5G data center in the 5G communication network that selectively enables network slice features.

FIG. 9 further illustrates the 5G data center in the 5G communication network that selectively enables network slice features.

FIG. 10 illustrates an exemplary operation of the 5G communication network to selectively enable network slice features.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECNICAL DESCRIPTION

A network slice is a type of network partition that groups a set of Radio Access Network (RAN) and core network resources that have capabilities to provide one or more service types. When user devices attach to the communication network over a wireless access node (e.g., a gNodeB), the user device may be assigned to a network slice based on the device’s subscription on the network, the device’s capabilities, and the device’s session requirements. Typically, user devices are assigned to network slices that the user devices are authorized to use and that have capabilities that align with the capabilities and session requirements of the user devices. Each network slice comprises a suite of network slice features like maximum allowed latency, Guaranteed Bit Rate (GBR), priority Quality-of-Service (QoS), dedicated bandwidth, priority scheduling, and/or other features to support service on the network slice. For example, an Ultra-Reliable Low-Latency Communications (URLLC) slice may comprise a maximum allowed latency slice feature to ensure user device communications on the slice are within an operator defined latency range. Some network slice features are computationally intensive to implement by wireless access nodes and/or consume a large amount of radio resources of the wireless access nodes.

Traditional wireless access nodes typically enable all of the features of the network slices that the user devices are assigned to when serving the user devices. However, when the capacity of a wireless access node is high (e.g., the node is lightly loaded and possess a large amount of available radio resources to serve user devices) and/or when the throughput requirements of a user device’s session are low (e.g., the user device is not streaming media, broadcasting media, online gaming, etc.), the wireless access node may be able to support the user device’s session requirements without implementing every feature of the network slice that the user device is assigned to. For example, if a wireless access node implements a dedicated bandwidth slice feature for a user device but the user device’s session requires a fraction (e.g., a third) of the dedicated bandwidth, the wireless access node would be wasting radio resources. Wireless access nodes do not take into account current network conditions and user device session requirements when providing network slice features to user devices. Implementing computationally and radio resource intensive network slice features when they are not needed to meet the user device’s session requirements wastes the computing and radio resources of the wireless access nodes.

To overcome the above-described problems in conventional wireless communication networks, various embodiments of the present technology relate to selectively enabling network slice features based on current network conditions and user device session requirements. In some examples, a wireless access node directs a user device to report network conditions at its location as well as session requirements for its data session. The wireless access node derives the required throughput to support the user device’s data session based on the reported metrics. The wireless access node selects and enables features of the user device’s network slice based on the required throughput and the capacity of the wireless access node. The enabled features may comprise every feature of the network slice or a subset of the features. Alternatively, the wireless access node may disable every feature of the network slice and serve the user device using best effort service. By using network conditions and session requirements as inputs to selectively enable the features of the user device’s network slice, wireless access nodes more efficiently allocate their computing and radio resources thereby improving overall network performance. Now referring to the Figures.

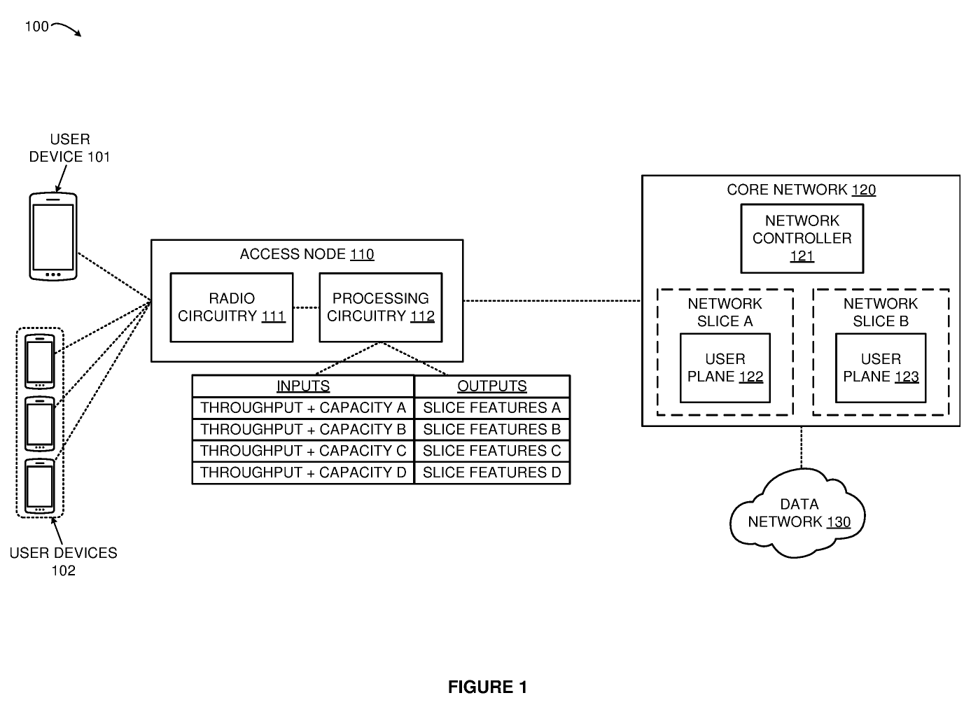

FIG. 1 illustrates communication network 100 to selectively enable network slice features. Communication network 100 provides services like media-streaming, media-broadcasting, internet-access, voice/video calling, text messaging, online gaming, social media, machine communications, remote device control, and/or some other wireless communications product. Communication network 100 comprises user device 101, user devices 102, access node 110, core network 120, and data network 130. Access node 110 comprises radio circuitry 111 and processing circuitry 112. Processing circuitry 112 hosts a data structure that correlates user device session throughput requirements and access node capacities with network slice features. Core network 120 comprises network controller 121 and user planes 122 and 123. As illustrated in FIG. 1, user plane 132 may be used to form network slice A and user plane 133 may be used to form network slice B. In other examples, communication network 100 may comprise additional or different elements than those illustrated in FIG. 1.

Various examples of network operation and configuration are described herein. In some examples, user devices 102 attach to access node 110 over radio circuitry 111. Processing circuitry 112 exchanges signaling with user devices 102 to establish wireless data and signaling links. User devices 102 communicate with network controller 121 in core network 120 over access node 110 to request wireless data services over access node 110. Network controller 121 approves the service requests and assigns user devices 102 to network slices A and B based on the services user devices 102 are authorized to receive. Network controller 121 directs access node 110 and user planes 122 and 123 to serve user devices 102. User devices 102 wirelessly exchange user data with data network 130 over access node 110 and core network 120.

User device 101 attaches to radio circuitry 111 and processing circuitry 112 exchanges signaling with user device 101 to establish wireless data and signaling links. User device 101 transfers a registration request to network controller 121 over access node 110 to register for service with core network 120. Network controller 121 authenticates the identity of user device 101 and authorizes user device 101 for service on communication network 100. Network controller 121 accesses a network data system that stores a subscriber profile and assigns user device 101 to a network slice(s) (e.g., network slice A and/or B) based on user device 101’s subscription on communication network 100. Network controller 121 directs ones of user planes 122 and 123 that correspond to the assigned network slice(s) to serve user device 101. Network controller 121 directs processing circuitry 112 to serve user device 101 and indicates the network slice(s) of user device 101 to processing circuitry 112.

Processing circuitry 112 directs user device 101 to measure network conditions and indicate session requirements. Exemplary network conditions include user device 101’s transmit power, the Signal-To-Interference-Plus-Noise Ratio (SINR) at the location of user device 101, and the amount of data user device 101 has buffered, and the like. Exemplary session requirements include Quality-of-Service Class Indicator (QCI) and the like. User device 101 measures/determines the network conditions and session requirements in response to the direction from processing circuitry 112. Processing circuitry 112 receives a measurement report from user device 101 over radio circuitry 111 that characterizes a session requirement of user device 101 and a radio condition of access node 110. Processing circuitry 112 determines the required throughput for user device 101’s data session based on the session requirement and radio condition included in the measurement report. For example, the measurement report may include a transmit power metric, a session QCI indication, a Buffer Status Report (BSR) that indicates the amount of buffered uplink data, and an uplink SINR measurement for user device 101. Processing circuitry 112 may determine the required Megabits Per Second (Mbps) to support user device 101’s data session based on the transmit power metric, session QCI indication, BSR, and uplink SINR measurement.

The network slice(s) user device 101 is assigned to comprises a number of network slice features. Exemplary network slice features include maximum latency, GBR, QoS level, dedicated bandwidth, priority scheduling, and the like. Processing circuitry 112 selects one or more of the network slice features of the network slice that user device is assigned to based on the required throughput of user device 101’s data session and the overall capacity of access node 110. For example, processing circuitry 112 may host a data structure that implements the correlation table illustrated in FIG. 1. The correlation table associates combinations of throughputs and capacities A-D with slice feature sets A-D. Processing circuitry 112 may input the determined throughput and capacity into the data structure as input to obtain a slice feature selection as output. Processing circuitry 112 selects fewer network slice features as the required throughput of user device 101 decreases. Processing circuitry 112 selects fewer network slice features as the capacity of access node 110 increases. Processing circuitry 112 enables the selected network slice features for user device 101’s data session. In some examples, processing circuitry 112 may select no network slice features based on the required throughput and capacity and instead enable default (e.g., best effort) service. The default service on the network slice may be understood to be a network slice feature itself, however if the network slice feature for default service is enabled, the other network features of the network slice would typically be disabled. Accordingly, user device 101 may send data to and receive data from data network 130 via the selected network slice(s) using the enabled network slice features (if any) over access network 110 and one or more of user plane 122 or user plane 123. For example, in some instances, user device 101 may exchange user data with processing circuitry 112 over radio circuitry 111. Processing circuitry 112 may exchange the user data with user plane 122 and/or user plane 123. User plane 122 and/or user plane 123 may exchange the user data with data network 130.

It should be appreciated that as the required throughput for a data session decreases, the number of network slice features needed to meet the throughput requirements of the data session also decreases. For example, priority scheduling for user device 101’s session may not be needed when user device 101’s required throughput is below a threshold. Likewise, as the overall capacity of access node 110 increases, the amount of radio resources available to serve user device 101 increases and the number of network slice features needed to meet the throughput requirements decreases. For example, if access node 110 is lightly loaded (e.g., the number of user devices 102 is low), default/best effort service to user device 101 may be able to meet the throughput requirements associated with user device 101. As such, optimal or otherwise preferred network conditions allow processing circuitry 112 to disable network slice features while still supporting session requirements which helps to conserve the resources of access node 110 and increase overall network efficiency.

Advantageously, communication network 100 effectively enables network slice features when serving user devices based on the current network conditions and the session requirements associated with the user devices. This efficiently uses access node computing and radio resources to maintain the user device’s session requirements thereby improving overall network performance while meeting end user expectations.

User device 101 and user devices 102 may comprise phones, computers, vehicles, drones, robots, sensors, or other types of data appliances with wireless and/or wireline communication circuitry. User device 101, user devices 102, and access node 110 may communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Access node 110 may comprise a tower (e.g., to mount radio circuitry 111 at elevation), another type of mounting structure (e.g., a building), or no mounting structure at all. Access node 110 may comprise a Sixth Generation (6G) Radio Access Network (RAN) node, Fifth Generation (5G) RAN node, LTE RAN node, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. Although access node 110 is illustrated as comprising a terrestrial access node, in some examples access node 110 may comprise a non-terrestrial (e.g., satellite based) access node. Access node 110 exchanges network signaling and user data with network functions clustered together into core network 120. Access node 110 is connected to core network 120 over one or more backhaul data links. Access node 110 and core network 120 may communicate via edge networks like internet backbone providers, edge computing systems, or another type of edge system to provide the backhaul data and signaling links between access node 110 and core network 120.

Access node 110 may comprise Radio Units (RUs), Distributed Units (DUs) and Centralized Units (CUs). For example, processing circuitry 112 may be representative of a DU and a CU while radio circuitry 111 may be representative of an RU. The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to core network 120. The CUs handle higher wireless network layers like the Radio Resource Control (RRC), Service Data Adaption Protocol (SDAP), and Packet Data Convergence Protocol (PDCP). The CUs are coupled to network functions in core network 120. Alternatively, may comprise RUs and Baseband Units (BBUs). The BBUs are usually nearby network computers and handle network layers like RRC, SDAP, PDCP, RLC, MAC, and PHY. The BBUs are coupled to network functions in core network 120.

Core network 120 is representative of computing systems that provide wireless data services to user device 101 and user devices 102 over access node 110. Exemplary computing systems comprise Network Function Virtualization Infrastructure (NFVI) systems, data centers, server farms, cloud computing networks, hybrid cloud networks, and the like. Core network 120 may comprise a 3GPP core network architecture like Sixth Generation Core (6GC), Fifth Generation Core (5GC), Evolved Packet Core (EPC), and/or another type of 3GPP core network architecture. Access node 110, core network 120, and data network 130 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocol. The computing systems of core network 120 store and execute the network functions/entities to form a control plane (e.g., network controller 121) and a user plane (e.g., user planes 122 and 123). Exemplary control plane network functions include Access and Mobility Management Function (AMF), Session Management Function (SMF), and the like. Exemplary user plane network functions include User Plane Function (UPF) and the like.

Network slices A and B are representative of collections of network elements (e.g., UPFs, control plane network functions, access nodes, etc.) with capabilities to support different service types over access node 110. For example, network slice A may comprise low-latency capabilities to support low-latency data sessions while network slice B may comprise high-uplink bandwidth capabilities to support media broadcasting sessions. Exemplary network slice types include Enhanced Mobile Broadband (eMBB), URLLC, Massive Machine-Type Communications (mMTC) slice, Vehicle To Everything (V2X), Fixed Wireless Access (FWA), private, and the like. While illustrated as comprising user planes 122 and 123, portions of network slices A and B may reside in network controller 121, access node 110, or in other locations within communication network 100.

Data network 130 comprises application servers, gateways, routers, Content Distribution Networks (CNDs) and/or other communication devices to participate in data sessions with user device 101 and user devices 102. For example, data network 130 may comprise an application server that hosts the server-side component of a user application executing on user device 101. Data network 130 may be representative of a public data network (e.g., the Internet) or a private data network (e.g., an enterprise network). Core network 120 and data network 130 may communicate via links provided by internet backbone providers, edge computing services, and/or other communication services that provide the data links between core network 120 and data network 130.

User device 101, user devices 102, and access node 110 comprise antennas, amplifiers, filters, modulation, analog/digital interfaces, microprocessors, software, memories, transceivers, bus circuitry, and the like. User device 101, user devices 102, access node 110, core network 120, and data network 130 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories comprise Random Access Memory (RAM), Solid State Drives (SSDs), Hard Disk Drives (HDDs), Non-Volatile Memory Express (NVMe) SSDs, and/or the like. The memories store software like operating systems, user applications, radio applications, and network functions. The microprocessors retrieve the software from the memories and execute the software to drive the operation of communication network 100 as described herein.

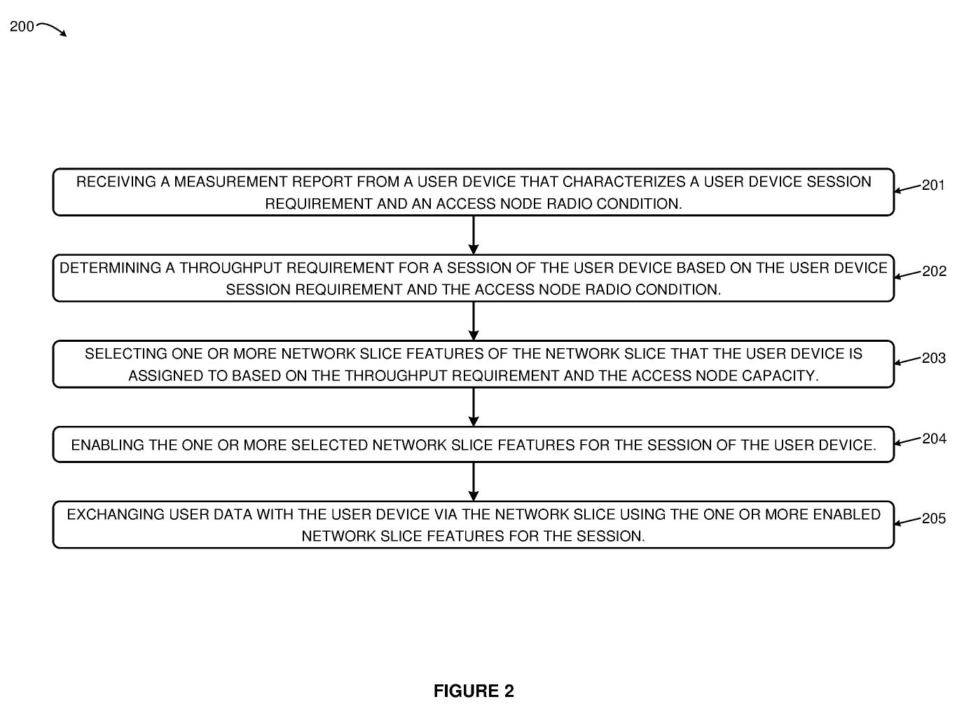

FIG. 2 illustrates process 200. Process 200 comprises an exemplary operation of communication network 100 to selectively enable network slice features. Process 200 may vary in other examples. The operations of process 200 comprise receiving a measurement report from a user device that characterizes a user device session requirement and an access node radio condition (step 201). The operations further comprise determining a throughput requirement for a session of the user device based on the user device session requirement and the access node radio condition (step 202). The operations further comprise selecting one or more network slice features of the network slice that the user device is assigned to based on the throughput requirement and the access node capacity (step 203). The operations further comprise enabling the one or more selected network slice features for the session of the user device (step 204). The operations further comprise exchanging user data with the user device via the network slice using the one or more enabled network slice features for the session (step 205).

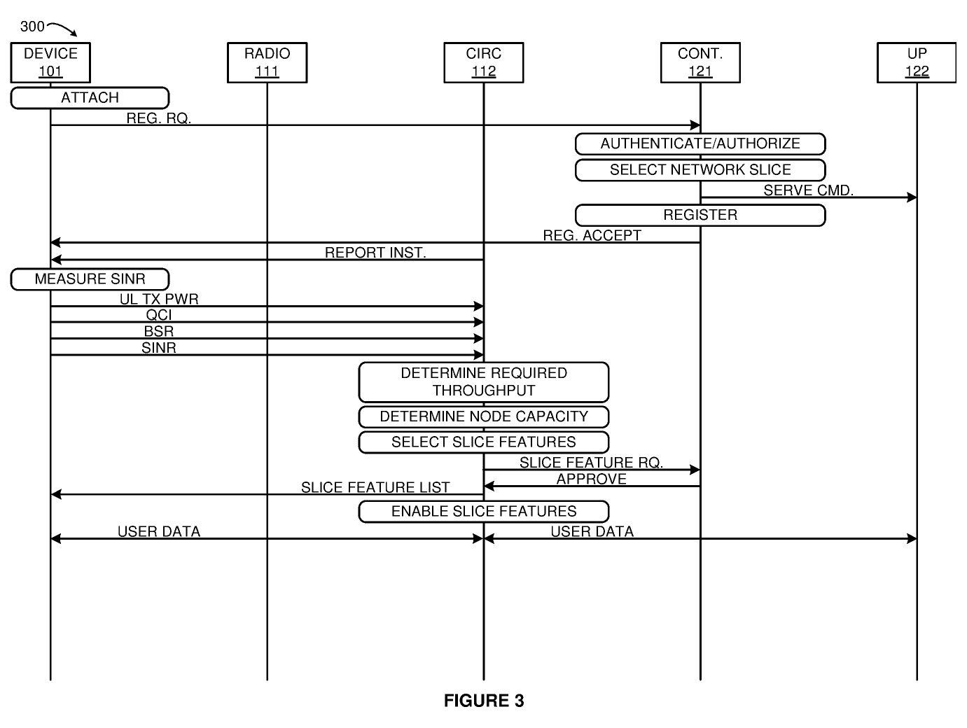

FIG. 3 illustrates process 300. Process 300 comprises an exemplary operation of communication network 100 to selectively enable network slice features. Process 300 comprises an example of process 200 illustrated in FIG. 2, however process 200 may differ. Process 300 may vary in other examples. In some examples, access node 110 serves user devices 102. Processing circuitry (CIRC) 112 exchanges user data with user devices 102 over radio circuitry 111 and exchanges the user data with user planes 122 and 123.

Radio circuitry 111 broadcasts reference signals. The reference signals include information which is used by user devices to initiate communications with access node 110. User device 101 receives the reference signals and measures signal strength of the signals. When the signal strength of the reference signals exceeds quality and/or strength thresholds (e.g., Received Signal Received Power (RSRP) thresholds, Received Signal Received Quality (RSRQ) thresholds, etc.), user device 101 decides to attach to access node 110.

User device 101 transfers attachment signaling to processing circuitry 112 over radio circuitry 111 based on the reference signals. Processing circuitry 112 returns a random access response to user device 101 over radio circuitry 111. The response comprises information like a timing advance command, uplink grant, and temporary identifier. User device 101 generates and transfers a connection setup request using the uplink grant at the times specified by the timing advance command to processing circuitry 112 over radio circuitry 111. For example, the connection setup request may comprise a Radio Resource Control (RRC) setup request. Processing circuitry 112 allocates radio resources to user device 101 to establish a wireless connection with user device 101.

In response to connection setup, user device 101 transfers a registration request (REG RQ) to network controller 121 over access node 110. The registration request includes information like subscriber Identifier (ID), device capabilities, Protocol Data Unit (PDU) session requests, and the like. Network controller 121 authenticates user device 101 and authorizes user device 101 for service on communication network 100. Network controller 121 determines user device is subscribed for service on network slice A. For example, network controller 121 may access a subscriber profile for user device 101 and retrieve a service attribute (e.g., an Address Value Pair (AVP)) that indicates user device 101 is subscribed for service on network slice A. Network controller 121 transfers a serve command (CMD) to user plane (UP) 122 to serve user device 101 based on user device 101’s subscription for network slice A. Responsive to authentication and authorization, Network controller 121 registers user device 101 for service on communication network 100. Network controller 121 directs processing circuitry 112 to serve user device 101. Network controller 121 notifies processing circuitry 112 that user device 101 is assigned to network slice A. Network controller 121 transfers a registration (REG) accept message for user device 101 to processing circuitry 112. The registration accept message includes information like device context, network addresses, and/or other information for user device 101 to begin its data session.

Processing circuitry 112 transfers the registration accept messages to user device 101 over radio circuitry 111. Processing circuitry 112 generates and transfers a report instruction (INST) to user device 101. The instruction directs user device 101 to report is transmit power (UL TX PWR), session QCI, a BSR, and SINR measured on the uplink to access node 110. User device 101 measures SINR on the uplink at its location. User device 101 determines its transmit power, the QCI for its data session, and generates a BSR based on the amount of queued uplink data. User device 101 transfers a measurement report that includes the BSR and that indicates the transmit power, QCI, and SINR to processing circuitry 112 over radio circuitry 111.

Processing circuitry 112 determines the required throughput to support user device 101’s session based on the BSR, transmit power, QCI, and SINR. For example, processing circuitry 112 may host a data structure that correlates queued uplink data, transmit power, QCI, and SINR to uplink/downlink Mbps requirements. Processing circuitry 112 determines an amount of available radio resources and an amount of required radio resources to maintain access node priority services to determine the capacity of access node 110. For example, processing circuitry 112 may compare the number of scheduled Physical Resource Blocks (PRBs) to the total number of PRBs supported by access node 110 to determine the capacity.

Processing circuitry 112 selects one or more of network slice A’s available features based on the throughput and the capacity. For example, network slice A may comprise features for priority scheduling and bandwidth reservation. Processing circuitry 112 may determine that priority scheduling is needed but bandwidth reservation is not needed to support user device 101’s session based on the session throughput requirement and access node capacity and in response, select priority scheduling. Processing circuitry 112 transfers a slice feature request (RQ) to network controller 121 that indicates the selected network slice features. Network controller 121 approves the selection and indicates the approval to processing circuitry 112. Processing circuitry 112 transfers a slice feature list to user device 101 over radio circuitry 111 that indicates the selected network slice features. For example, processing circuitry 112 may transfer Downlink Control Information (DCI) signaling to user device 101 that directs user device 101 to enable the selected features of network slice A. In response to receiving the approval from network controller 121 and indicating the selected features to user device 101, processing circuitry 112 enables the selected network slice features.

Processing circuitry 112 schedules user device 101 in uplink and downlink PRBs for data reception/transmission. Processing circuitry 112 controls radio circuitry 111 to wirelessly exchange user data with user device 101 based on the scheduling. Processing circuitry 112 applies the enabled network slice features to the data session. Processing circuitry 112 exchanges the user data with user plane 122 in network slice A which in turn exchanges the user data with data network 130.

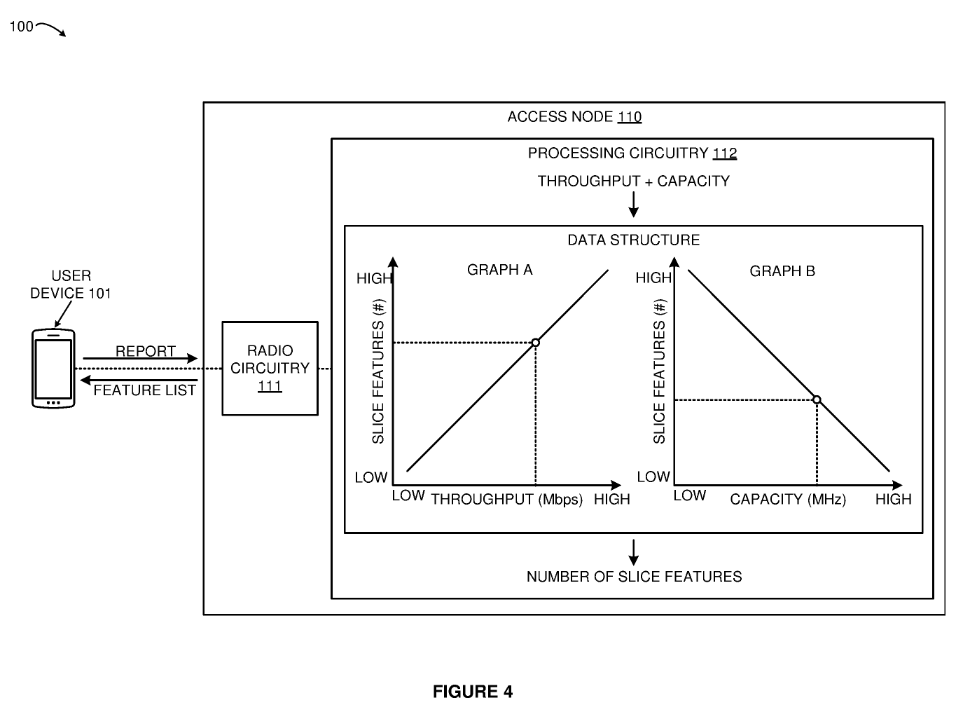

FIG. 4 illustrates access node 110 in communication network 100. In some examples, processing circuitry 112 hosts a data structure that implements the graphs (labeled Graph A and Graph B) illustrated in FIG. 4. The horizontal axis of Graph A indicates a throughput in Mbps in an exemplary range: Low to High. The vertical axis of Graph A indicates a number of slice features in an exemplary range: Low to High. For example, the number of slice features may range from a single feature for default service to every feature available on the network slice aside from the default service feature. As indicated by the X mark on Graph A, a throughput amount correlates to a number of slice features. The horizontal axis of Graph B indicates a capacity in Megahertz (MHz) in an exemplary range: Low to High. While capacity is measured in MHz (e.g., indicating available bandwidth), other units like Mbps may be used to quantify the capacity of access node 110. The vertical axis of Graph B indicates a number of slice features in an exemplary range: Low to High. As indicated by the X mark on Graph B, a capacity amount correlates to a number of slice features. The terms Low and High used in Graphs A and B are illustrative and numerical values could be used. The curve in Graph A indicates that as the required throughput for user device 101’s data session increases, the number of slice features needed to support the data session also increases. The curve in Graph B indicates that as the capacity of access node 110 increases, the number of slice features needed to support user device 101’s data session decreases.

In some examples, processing circuitry 112 receives a report from user device 101 over radio circuitry 111 that characterizes network conditions associated with user device 101 like SINR, transmit power, BSR, QCI, and the like. Processing circuitry 112 derives the required throughput for user device 101’s data session based on the metrics included in the report. Processing circuitry 112 accesses a scheduler for access node 110 (e.g., a MAC) to determine access node 110’s available bandwidth for serving user device 101. Processing circuitry 112 inputs the throughput and capacity into the data structure. The data structure correlates the throughput and capacity to a number of network slice features and provides the number of slice features to processing circuitry 112 as an output. For example, the data structure may use a weighted sum to combine the outputs from Graph A and Graph B to determine the needed number of slice features. The data structure may comprise additional intelligence to select specific ones of the network slice features available in user device 101’s network slice based on user device 101’s session type and/or other session requirements. For example, the data structure may select a low-latency slice feature over a priority scheduling slice feature for a latency sensitive data session.

Processing circuitry 112 receives output from the data structure and in response, selects slice features for user device 101. Processing circuitry 112 interfaces network controller 121 to enable the selected slice features and transfers a feature list (e.g., in DCI signaling) to user device 101 over radio circuitry 111 to notify user device 101 of the enabled slice features. User device 101 exchanges user data with data network 130 over access node 110 and core network 120. Processing circuitry 112 treats the traffic of user device 101’s session using the enabled slice features.

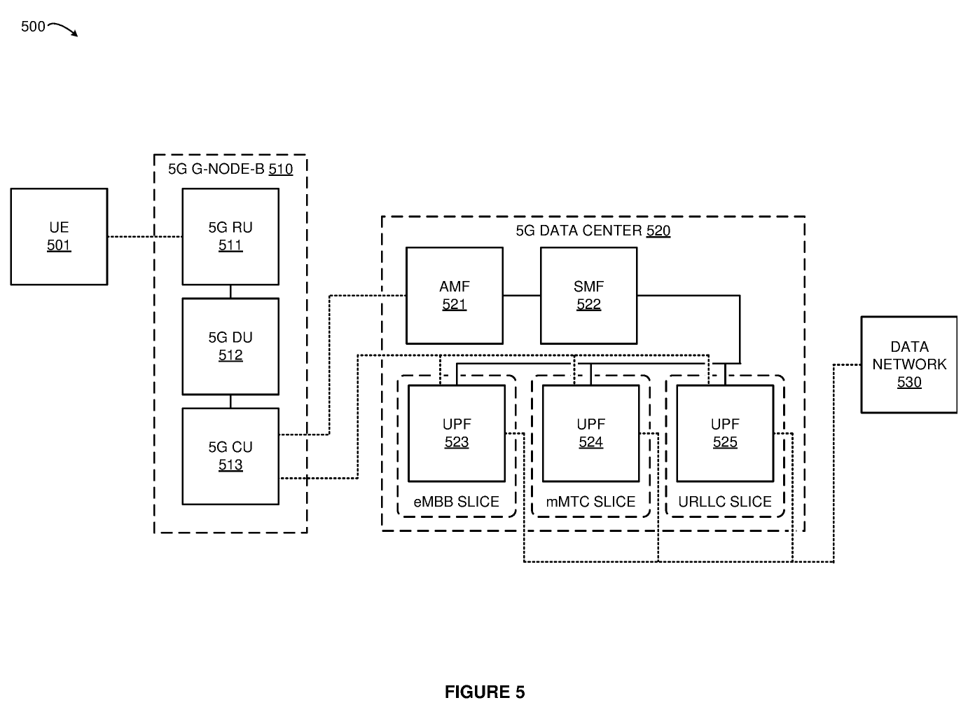

FIG. 5 illustrates 5G communication network 500 to selectively enable network slice features. 5G communication network 500 comprises an example of communication network 100 illustrated in FIG. 1, however communication network 100 may differ. 5G communication network 500 comprises 5G UE 501, 5G gNodeB 510, 5G data center 520, and data network 530. 5G gNodeB 510 comprises 5G RU 511, 5G DU 512, and 5G CU 513. 5G data center 520 comprises AMF 521, SMF 522, and UPFs 523-525. Other network functions and network entities like Unified Data Management (UDM), Policy Control Function (PCF), Authentication Server Function (AUSF), Network Slice Selection Function (NSSF), Charging Function (CHF), Home Subscriber Register (HLR), Home Subscriber Server (HSS), Network Repository Function (NRF), Unified Data Registry (UDR), Short Message Service Function (SMSF), Network Exposure Function (NEF), Application Function (AF), Equipment Identity Register (EIR), and Session Communication Proxy (SCP) are typically present in 5G data center 520 but are omitted for clarity. 5G data center 520 comprises an eMBB slice, an mMTC slice, and a URLLC slice. UPF 523 forms the eMBB slice, UPF 524 forms the mMTC slice, and UPF 525 forms the URLLC slice. Although illustrated as only comprising UPFs, the eMBB slice, mMTC slice, and URLLC may comprise other network elements in 5G communication network 500. Moreover, some elements may be shared between different ones of the network slices. For example, the eMBB slice and the mMTC slice may both comprise SMF 522. It should be appreciated that 5G communication network 500 typically comprises many more network slices and slice types (e.g., V2X slices, FWA slices, private slices, etc.) and that three distinct slices are shown for clarity. In other examples, 5G communication network 500 may comprise different or additional elements than those illustrated in FIG. 5.

In some examples, 5G gNodeB 510 serves UE 501 over radio a channel in a cell. 5G gNodeB 510 typically serves other UEs in its cell however the other UEs are omitted for clarity. UE 501 detects a synchronization signal broadcast by 5G gNodeB 510 and decides to attach. UE 501 wirelessly attaches to 5G gNodeB 510 over a 5GNR link and transfers random preamble to 5G gNodeB 510 initiating a Random Access Channel (RACH) procedure to establish a secure signaling channel. 5G gNodeB 510 receives the preamble and assigns a Cell-Radio Network Temporary Identifier (C-RNTI) to UE 501. 5G gNodeB 510 wirelessly transfers a random access response to UE 501. The random access response includes a timing advance command, uplink grant, and the C-RNTI. The uplink grant indicates the time and frequency domain resources assigned to UE 501. UE 501 wirelessly receives the random access response. UE 501 extracts the uplink grant and timing advance command from the response. UE 501 transfers an RRC setup request to 5G gNodeB 510 using the frequency and time resources assigned by the uplink grant at the time indicated by the timing advance command. The RRC setup request comprises a UE identity indication and the establishment cause. 5G gNodeB 510 establishes a radio signaling bearer for UE 501 and transfers an RRC setup message to UE 501. The RRC setup message comprises a radio bearer configuration and cell ID. UE 501 establishes an RRC connection with 5G gNodeB 510 using the radio bearer configuration and cell ID.

UE 501 transfers a registration request to AMF 521 over 5G gNodeB 510 and the radio signaling bearer. The registration request indicates a registration type, 5G-Global Unique Temporary Identifier (GUTI), Tracking Area Identifier (TAI), Network Slice Selection Assistance Information (NSSAI) requests, UE capabilities, PDU session requests, and the like. In response to the registration request, AMF 521 transfers a Non-Access Stratum (NAS) identity request to UE 501 over 5G gNodeB 510 and the radio signaling bearer. UE 501 indicates its Subscriber Concealed Identifier (SUCI) to AMF 521 over 5G gNodeB 510. AMF 521 interfaces with other network functions to authenticate the identity of UE 501. Typically, authentication involves presenting a random number challenge to UE 501 and matching an authentication response from UE 501 with an expected result to verify the identity of UE 501.

Responsive to the authentication, AMF 521 interfaces with other network functions to generate context for UE 501. The UE context defines the authorized services for UE 501. To form the context, AMF 521 retrieves access and mobility subscription data, SMF selection subscription data, and UE context in SMF data from a network data system (e.g., a UDM/UDR). The access and mobility subscription data comprises a supported feature list for UE 501 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of allowed S-NSSAIs and associated information. The UE context in SMF data comprises PDU session and EPC interworking information. AMF 521 forms the UE context for UE 501 using the retrieved information. AMF 521 interfaces with other network functions to retrieve policy association information for UE 501. The policy association information comprises the SUPI, GPSI, PEI, and user location information for UE 501. AMF 521 interfaces with other network functions to select a network slice for UE 501 based on the UE context, the policy association information, NSSAI requests received from UE 501, and the like. Typically, AMF 521 assigns UE 501 to a network slice that it is subscribed to receive service on. For example, if UE 501 is subscribed for service on the eMBB slice, AMF 521 may assign UE 501 to the eMBB slice.

AMF 521 selects SMF 522 to serve UE 501 based on SMF selection data, the policy association information, and/or the network slice assigned to UE 501. AMF 521 transfers a list of requested PDU sessions (as received during the registration request), a PDU session activation command, the SUPI, and typically other information associated with UE 501 to SMF 522. SMF 522 receives the PDU session list, session activation command, and the SUPI from AMF 521. SMF 522 allocates an IP address to UE 501 for the requested PDU session and allocates a Tunnel Endpoint Identifier (TEID) for the session. SMF 522 selects one or more of UPFs 523-525 to serve UE 501 based on UE 501’s network slice(s). SMF 522 transfers a session modification request that includes a session endpoint identifier and TEID to the selected one(s) of UPFs 523-525 to set up the PDU session for UE 501. The selected one(s) of UPFs 523-525 sets up a default bearer for UE 501 with 5G gNodeB 510. The default bearer is a link to carry IP packets for UE 501’s PDU session. The selected one(s) of UPFs 523-525 transfers a session modification response to SMF 522 that includes the session endpoint identifier to confirm bearer setup.

SMF 522 returns a PDU session create response to AMF 521 to confirm session creation. The response includes the updated session context (e.g., allocated IP addresses, TEID, etc.). In response, AMF 521 registers UE 501 for service on 5G data center 520. AMF 521 generates a registration accept message that includes the allocated UE IP address, RAN ID, AMBR, Globally Unique AMF ID (GUAMI), PDU session ID, PDU session TEID, allowed NSSAI list, security data, and the like. AMF 521 transfers the registration accept message to 5G gNodeB 510 to direct 5G gNodeB 510 to serve UE 501.

5G gNodeB 510 transfers an RRC reconfiguration message to UE 501 to setup the data radio bearers. The message includes cell IDs, bearer configuration information, and the like. The message also directs UE 501 to report its transmit power, BSR, session QCI, and SINR at its location. UE 501 configures its radio bearers using the received information. UE 501 measures the amount of uplink data it has buffered to generate the BSR. UE 501 measures the received signal from 5G gNodeB 510 as well as received interference and noise to calculate SINR. UE 501 determines its transmit power. UE 501 transfers a status report that indicates its transmit power, session QCI, and SINR and that includes the BSR to 5G gNodeB 510.

5G gNodeB 510 determines the required throughput for UE 501 based on the transmit power, SINR, session QCI, and the amount of buffered data indicated in the BSR. For example, 5G gNodeB 510 may host a function that algorithmically correlates transmit power, session QCI, SINR, and buffered data amount to an estimated throughput requirement in Mbps. 5G gNodeB 510 determines its capacity based on the amount of radio resources available for uplink/downlink communications. The eMBB slice, mMTC slice, and URLLC slice are representative of physical network slices. 5G gNodeB 510 selects a virtual network slice within the physical network slice of UE 501 based on the calculated throughput requirement, the capacity of 5G gNodeB 510, session specific requirements (e.g., low-latency), and the like. A physical network slice in 5G communication network 500 comprises a set of available network slice features. A virtual network slice comprises a subset of the available network slice features of a corresponding physical network slice. Each physical network slice comprises a virtual network slice for default bearer service (e.g., best effort service) and one or more additional virtual network slices with sets of the features available in the network slice. For example, the URLLC slice may comprise features for low-latency, GBR, QoS level, dedicated bandwidth, and priority scheduling. The URLLC slice may comprise a virtual slice for default service (e.g., all slice features disabled), a virtual slice that enables low-latency and priority scheduling, a virtual slice that enables all the features of the URLLC slice, and/or other virtual slices.

5G gNodeB 510 signals AMF 521 to assign UE 501 to the selected virtual network slice within UE 501’s physical network slice. AMF 521 approves the request and directs SMF 522 to enable the network slice features of the virtual network slice. SMF 522 directs the one(s) of UPFs 523-525 that corresponds to the selected network slice(s) to enable the features of the selected virtual slice. AMF 521 notifies 5G gNodeB 510 that UE 501 has been assigned to the selected virtual network slice. 5G gNodeB 510 transfers DCI signaling to UE 501 that indicates the features of the virtual network slice. In response, UE 501 begins its PDU session on 5G communication network 500. 5G gNodeB 510 schedules PRBs for UE 501 to assign time and frequency domain resources for the PDU session based on the registration accept message. 5G gNodeB 510 wirelessly exchanges user data with UE 501 using the PRBs assigned to UE 501. 5G gNodeB 510 treats the traffic exchanged with UE 501 using the features of UE 501’s virtual slice within UE 501’s physical network slice. 5G gNodeB 510 exchanges the user data with one(s) of UPFs 523-525 that corresponds to UE 501’s physical network slice. The one(s) of UPFs 523-525 exchanges the user data with data network 530.

5G gNodeB 510 may periodically (e.g., every 100ms-1s) recalculate the required session throughput and its capacity and maintain a floating average of the throughput and capacity for UE 501’s session. 5G gNodeB 510 may reselect virtual slices for UE 501 as the floating average of the throughput and capacity changes with changing network conditions. For example, as the capacity of 5G gNodeB 510 decreases and/or the throughput for UE 501 increases, 5G gNodeB 510 may reassign UE 501 to another virtual slice that enables more or different network slice features to maintain the session requirements of UE 501. Likewise, as the capacity of 5G gNodeB 510 increases and/or the throughput for UE 501 decreases, 5G gNodeB 510 may reassign to another virtual slice that enables fewer network slice features (or places UE 501 on the default service virtual slice) to maintain the session requirements of UE 501 while conserving network resources. 5G gNodeB 510 may include a hysteresis value in its virtual slice reselection processes to inhibit ping-pong behavior between the virtual network slices by UE 501.

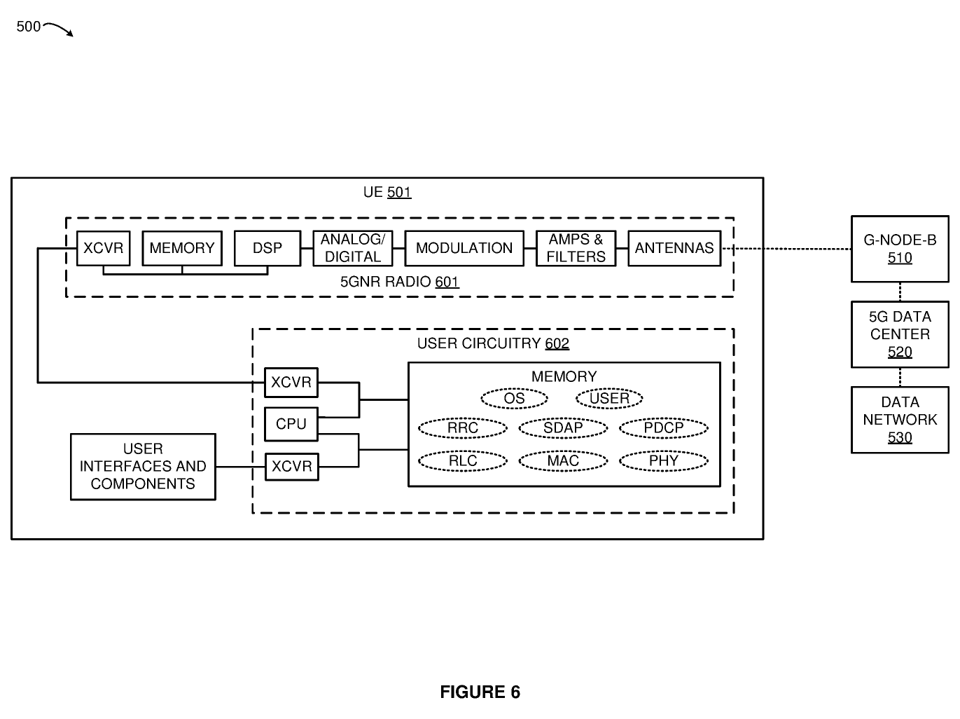

FIG. 6 illustrates UE 501 in 5G communication network 500. UE 501 comprises an example of user device 101 and user devices 102 illustrated in FIG. 1, although user device 101 and user devices 102 may differ. UE 501 comprises 5G radio 601 and user circuitry 602. 5G radio 601 comprises 5GNR antennas, amplifiers, filters, modulation, analog-to-digital interfaces, Digital Signal Processers (DSP), memory, and transceivers (XCVRs) that are coupled over bus circuitry. User circuitry 602 comprises memory, CPU, user interfaces and components, and transceivers that are coupled over bus circuitry.

The memory in user circuitry 602 stores an operating system (OS), user applications (USER), and 5GNR network applications for PHY, MAC, RLC, PDCP, SDAP, and RRC. The antenna in 5G radio 601 is wirelessly coupled to 5G gNodeB 510 over a 5GNR link. Transceivers in radio 601 are coupled to a transceiver in user circuitry 602. A transceiver in user circuitry 602 is typically coupled to user interfaces and components like displays, controllers, and memory.

In 5G radio 601, the antennas receive wireless signals from 5G gNodeB 510 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 602 over the transceivers. In user circuitry 602, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 601, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G gNodeB 510 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

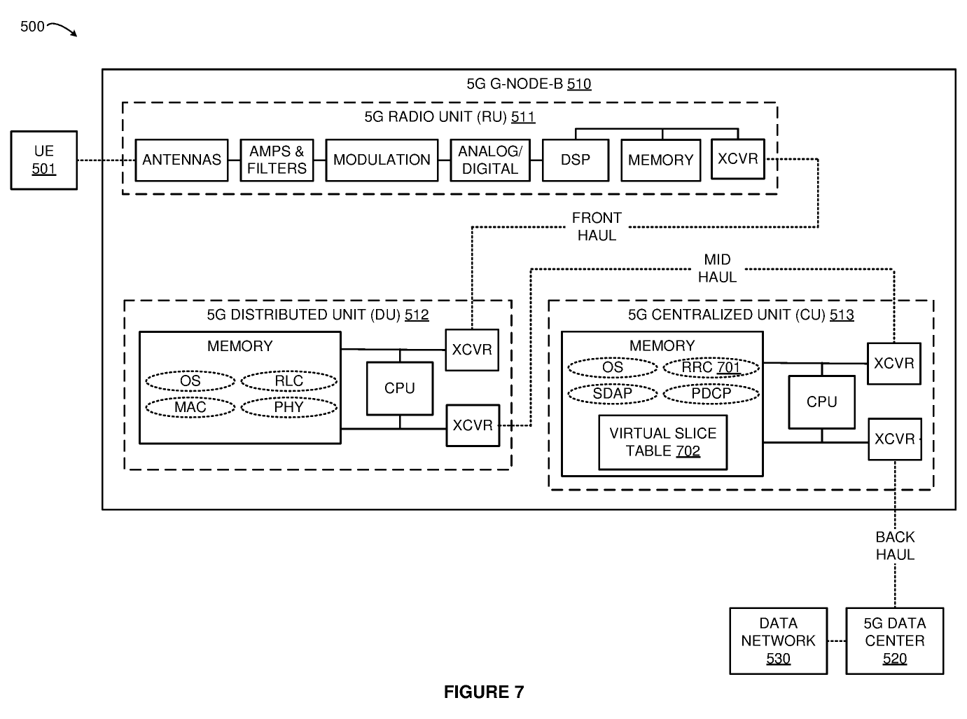

FIG. 7 illustrates 5G gNodeB 510 in 5G communication network 500. 5G gNodeB 510 comprises an example of the access node 110 illustrated in FIG. 1, although access node 110 may differ. RU 511 comprises 5GNR antennas, amplifiers, filters, modulation, analog-to-digital interfaces, DSP, memory, and transceivers (XCVRs) that are coupled over bus circuitry. UE 501 is wirelessly coupled to antennas in RU 511 over 5GNR links. Transceivers in RU 511 are coupled to transceivers in DU 512 over fronthaul links like enhanced Common Public Radio Interface (eCPRI). The DSPs in RU 511 executes their operating systems and radio applications to exchange 5GNR signals with UE 501 and to exchange 5GNR data with DU 512.

For the uplink, the antennas in RU 511 receive wireless signals from UE 501 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 512 over the transceivers.

For the downlink, the DSPs receive downlink 5GNR symbols from DU 512. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 501 that transport the downlink 5GNR signaling and data.

DU 512 comprises memory, CPU, and transceivers that are coupled over bus circuitry. The memory in DU 512 stores operating systems and 5GNR network applications like PHY, MAC, and RLC. CU 513 comprises memory, CPU, and transceivers that are coupled over bus circuitry. The memory in CU 513 stores an operating system, 5GNR network applications like PDCP, SDAP, and RRC 701 and virtual slice table 702. Transceivers in DU 512 are coupled to transceivers in RU 511 over front-haul links. Transceivers in DU 512 are coupled to transceivers in CU 513 over mid-haul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC 701 functions include authentication, security, handover control, status reporting, QoS, network broadcasts and pages, network selection, throughput requirement calculation, throughput/capacity based virtual slice selection, and virtual slice enablement. Virtual slice table 702 is representative of a data structure that correlates UE session throughput requirements and access node capacities with virtual network slices.

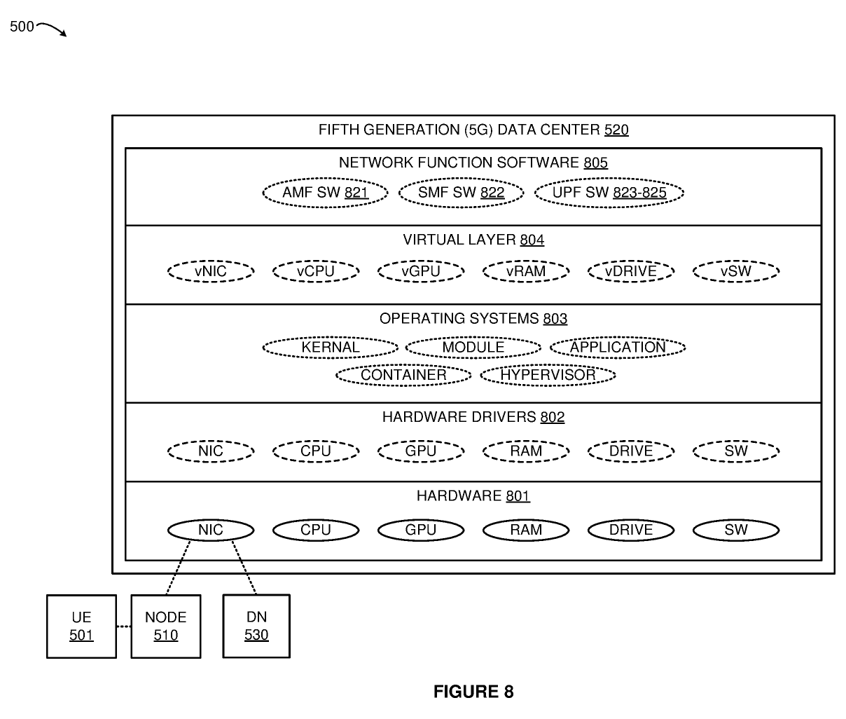

FIG. 8 illustrates 5G data center 520 in 5G communication network 500. 5G data center 520 comprises an example of core network 120 illustrated in FIG. 1, although core network 120 may differ. 5G data center 520 typically comprises a virtualized computing architecture like NFVI, but may comprise another computing architecture like a cloud computing network, a hybrid cloud network, and the like. 5G data center 520 comprises hardware 801, hardware drivers 802, operating systems 803, virtual layer 804, and network function software 805. Hardware 801 comprises Network Interface Cards (NICs), CPU, GPU, RAM, Flash/Disk Drives (DRIVE), and Data Switches (SW). Hardware drivers 802 comprise software that is resident in the NIC, CPU, GPU, RAM, DRIVE, and SW. Operating systems 803 comprise kernels, modules, applications, containers, hypervisors, and the like. Virtual layer 804 comprises vNIC, vCPU, vGPU, vRAM, vDRIVE, and vSW. Network function software 805 comprises AMF Software (SW) 821, SMF SW 822, and UPF SW 823-825. Additional network function software for network functions like AUST, NSSF, PCF, UDM, UDR, CHF, HLR, HSS, NRF, SMSF, NEF, AF, EIR, and SCP is typically present but is omitted for clarity. 5G data center 520 may be located at a single site or be distributed across multiple geographic locations. The NIC in hardware 801 is coupled to 5G gNodeB 510, data network (DN) 530, and to external systems (not illustrated). Hardware 801 executes hardware drivers 802, operating systems 803, virtual layer 804, and network function software 805 to form AMF 521, SMF 522, and UPFs 523-525.

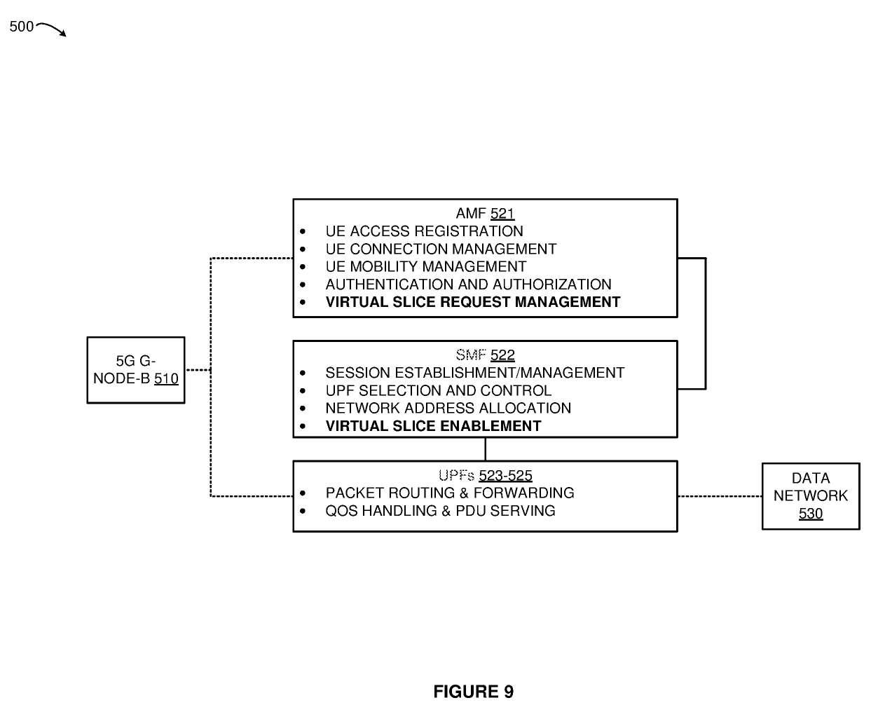

FIG. 9 further illustrates 5G data center 520 in 5G communication network 500. AMF 521 capabilities comprise UE access registration, UE connection management, UE mobility management, UE authentication, UE authorization, and virtual slice request management. SMF 522 capabilities comprise session establishment, session management, UPF selection, UPF control, network address allocation, and virtual slice enablement. UPFs 523-525 capabilities comprise pack routing, packet forwarding, QoS handling, and PDU serving.

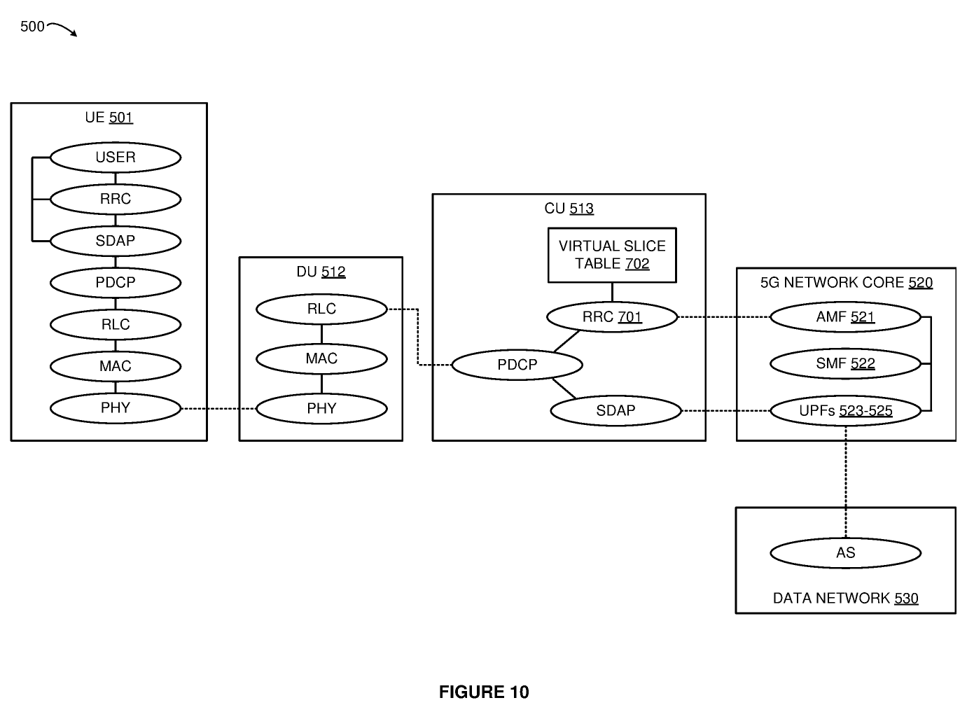

FIG. 10 illustrates an exemplary operation of 5G communication network 500 to selectively enable network slice features. The exemplary operation comprises an example of processes 200 and 300 illustrated in FIGS. 2 and 3, however processes 200 and 300 may differ. The exemplary operation may differ in other examples. In some examples, RRC 701 directs the SDAP in CU 513 to serve a PDU session to UE 501 in response to receiving a registration accept message from AMF 521. The registration accept message indicates UE 501 is assigned to the eMBB slice. RRC 701 transfers an RRC reconfiguration message to the RRC in UE 501 over the PDCPs, RLCs, MACs, and PHYs. The RRC reconfiguration message directs UE 501 to set up the data radio bearers and report its transmit power, BSR, session QCI, and SINR at its location. The RRC in UE 501 configures its radio bearers using the received information. The RRC interfaces with the MAC in UE 501 to determine the amount of buffered uplink data and generates the BSR to indicate the amount of buffered data. The RRC directs the PHY in UE 501 to measure the received signal from 5G gNodeB 510 as well as received interference and noise. The RRC calculates SINR based on the measured signal metrics. The RRC transfers a status report that indicates the transmit power, session QCI, and SINR and that includes the BSR to RRC 701 over the PDCPs, RLCs, MACs, and PHYs.

RRC 701 determines the required throughput for UE 501 in Mbps based on the transmit power, SINR, session QCI, and the amount of buffered data indicated in the BSR. RRC 701 interfaces with the MAC in DU 512 to determine the capacity of 5G gNodeB 510. The MAC reports the amount of available PRBs for uplink/downlink scheduling. RRC 701 inputs the required throughput (e.g., the Mbps value) and the capacity (e.g., number of available PRBs) into virtual slice table 702. Virtual slice table 702 correlates the throughput and capacity into a virtual slice of the eMBB slice. In this example, the eMBB slice comprises features for GBR, priority QoS, dedicated bandwidth, and priority scheduling, UE 501’s throughput is below a default service threshold, and 5G gNodeB 510’s capacity is above a default service threshold. As such, virtual slice table 702 correlates the throughput and capacity to the virtual slice for default bearer service to conserve network resources while meeting UE 501’s session requirements. Virtual slice table 702 indicates the selected virtual network slice to RRC 701.

RRC 701 signals AMF 521 to assign UE 501 to the selected virtual network slice within the eMBB slice. AMF 521 approves the request and directs SMF 522 to assign UE 501 to the default bearer service virtual slice of the eMBB slice. SMF 522 controls UPF 523 to serve UE 501 on the default bearer. AMF 521 notifies RRC 701 that UE 501 has been assigned to the selected virtual network slice. RRC 701 transfers DCI signaling to the RRC in UE 501. The DCI signaling directs UE 501 to exchange user data for the PDU session on the default bearer. RRC 701 directs the MAC in DU 512 to schedule UE 501 for wireless service. The MAC schedules UE 501 for uplink/downlink transmissions in PRBs. RRC 701 indicates the scheduled PRBs to the RRC in UE 501 over the PDCPs, RLCs, MACs, and PHYs. The RRC in UE 501 controls the lower layer network applications to send/receive signaling and data in the scheduled PRBs over the default bearer. The user application in UE 501 and the application server (AS) in data network 530 generate user data for the session. The SDAP in UE 501 exchanges the user data with the SDAP in CU 513 over the PDCPs, RLCs, MACs, and PHYs using the scheduled PRBs over the default bearer. The SDAP in CU 513 exchanges the user data with UPF 523. UPF 523 exchanges the user data with data network 530. SMF 522 monitors and controls UPF 523 to support the session.

RRC 701 directs the RRC in UE 501 report updated transmit power, BSR, session QCI, and SINR over the PDCPs, RLCs, MACs, and PHYs. The RRC in UE 501 interfaces with the lower layer network applications in UE 501 to calculate updated transmit power, BSR, session QCI, and SINR and reports the update values to RRC 701 over the PDCPs, RLCs, MACs, and PHYs. RRC 701 recalculates the required throughput for UE 501 based on the updated transmit power, SINR, session QCI, and the amount of buffered data indicated in the BSR. RRC 701 interfaces with the MAC in DU 512 to redetermine the capacity of 5G gNodeB 510. RRC 701 inputs the updated throughput and capacity into virtual slice table 702. At this point, the required throughput for UE 501 has increased and the capacity of 5G gNodeB 510 has decreased. Virtual slice table 702 correlates the throughput and capacity into a virtual slice that enables the eMBB slice features for a priority QoS level, dedicated bandwidth, and priority scheduling to maintain the service requirements for UE 501’s session given the increased throughput requirements and decreased capacity. Virtual slice table 702 indicates the selected virtual network slice to RRC 701.

RRC 701 signals AMF 521 to reassign UE 501 to the selected virtual network slice within the eMBB slice. AMF 521 approves the request and directs SMF 522 to assign UE 501 to the virtual slice of the eMBB slice that enables the priority QoS level, dedicated bandwidth, and priority scheduling. SMF 522 controls UPF 523 to serve UE 501 using the enabled slice features. AMF 521 notifies RRC 701 that UE 501 has been reassigned to the newly selected virtual network slice. RRC 701 transfers DCI signaling to the RRC in UE 501 that notifies UE 501 of the newly enabled network slice features. RRC 701 directs the MAC in DU 512 to schedule UE 501 for wireless service using priority scheduling on a dedicated bandwidth. The MAC schedules UE 501 in PRBs at a higher priority than default service and in the dedicated bandwidth. RRC 701 indicates scheduled PRBs to the RRC in UE 501 over the PDCPs, RLCs, MACs, and PHYs. The RRC in UE 501 controls the lower layer network applications to send/receive signaling and data in the scheduled PRBs. The user application in UE 501 and the application server in data network 530 generate additional user data for the session. The SDAP in UE 501 exchanges the user data with the SDAP in CU 513 over the PDCPs, RLCs, MACs, and PHYs using the uplink and downlink PRBs scheduled. The SDAP applies the priority QoS to the user data exchange. The SDAP in CU 513 exchanges the user data with UPF 523. UPF 523 exchanges the user data with data network 530. SMF 522 monitors and controls UPF 523 to support the session.

The wireless data network circuitry described above comprises computer hardware and software that form special-purpose network circuitry to selectively enable network slice features. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to selectively enable network slice features.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
receiving a measurement report from a user device that characterizes a user device session requirement and an access node radio condition;
determining a throughput requirement for a session of the user device based on the user device session requirement and the access node radio condition;
selecting one or more network slice features of a network slice that the user device is assigned to based on the throughput requirement and an access node capacity;
enabling the one or more selected network slice features for the session of the user device; and
exchanging user data with the user device via the network slice using the one or more enabled network slice features for the session.

2. The method of claim 1 wherein:
receiving the measurement report from the user device that characterizes the user device session requirement and the access node radio condition comprises receiving the measurement report from the user device that characterizes a user device transmit power; and
determining the throughput requirement for the session of the user device based on the user device session requirement and the access node radio condition comprises determining the throughput requirement for the session of the user device based on the user device transmit power.

3. The method of claim 1 wherein:
receiving the measurement report from the user device that characterizes the user device session requirement and the access node radio condition comprises receiving the measurement report from the user device that characterizes a session Quality-of-Service Class Indicator (QCI); and
determining the throughput requirement for the session of the user device based on the user device session requirement and the access node radio condition comprises determining the throughput requirement for the session of the user device based on the session QCI.

4. The method of claim 1 wherein:
receiving the measurement report from the user device that characterizes the user device session requirement and the access node radio condition comprises receiving the measurement report from the user device that characterizes a user device Buffer Status Report (BSR); and
determining the throughput requirement for the session of the user device based on the user device session requirement and the access node radio condition comprises determining the throughput requirement for the session of the user device based on the user device BSR.

5. The method of claim 1 wherein:
receiving the measurement report from the user device that characterizes the user device session requirement and the access node radio condition comprises receiving the measurement report from the user device that characterizes a Signal-To-Interference-Plus-Noise Ratio (SINR) at a location of the user device; and
determining the throughput requirement for the session of the user device based on the user device session requirement and the access node radio condition comprises determining the throughput requirement for the session of the user device based on the user device SINR at the location of the user device.

6. The method of claim 1 wherein:
receiving the measurement report from the user device that characterizes the user device session requirement and the access node radio condition comprises receiving the measurement report from the user device that characterizes a user device transmit power, a session Quality-of-Service Class Indicator (QCI), a user device Buffer Status Report (BSR), and a Signal-To-Interference-Plus-Noise Ratio (SINR) at a location of the user device; and
determining the throughput requirement for the session of the user device based on the user device session requirement and the access node radio condition comprises determining the throughput requirement for the session of the user device based on the user device transmit power, the session QCI, the user device BSR, and the SINR at the location of the user device.

7. The method of claim 1 further comprising determining the access node capacity based on an amount of available access node radio resources and an amount of required radio resources to maintain access node priority services.

8. The method of claim 1 wherein:
the network slice that the user device is assigned to comprises a set of available network slice features; and
selecting the one or more network slice features of the network slice that the user device is assigned to based on the throughput requirement and the access node capacity comprises selecting the one or more network slice features of the network slice from the set of available network slice features based on the throughput requirement and the access node capacity.

9. The method of claim 1 further comprising:
transferring a request to a network controller in a core network to enable the one or more selected network slice features for the session of the user device;
receiving a response from the network controller that approves enablement of the one or more selected network slice features; and
transferring Downlink Control Information (DCI) signaling that identifies and directs the user device to enable the one or more selected network slice features; and wherein:
enabling the one or more selected network slice features for the session of the user device comprises enabling the one or more selected network slice features for the session of the user device in response to receiving the response from the network controller and transferring the DCI signaling.

10. The system of claim 1 wherein the one or more network slice features comprise one or more of a default service, a maximum latency, a Guaranteed Bit Rate (GBR), a Quality-of-Service (QoS), a dedicated bandwidth, and a priority scheduling.

11. A system comprising:
processing circuitry in an access node configured to:
receive a measurement report from a user device that characterizes a user device session requirement and an access node radio condition;
determine a throughput requirement for a session of the user device based on the user device session requirement and the access node radio condition;
select one or more network slice features of a network slice that the user device is assigned to based on the throughput requirement and an access node capacity;
enable the one or more selected network slice features for the session of the user device; and
exchange user data with the user device via the network slice using the one or more enabled network slice features for the session.

12. The system of claim 11 wherein:
the measurement report characterizes a user device transmit power; and
the processing circuitry is further configured to determine the throughput requirement for the session of the user device based on the user device transmit power.

13. The system of claim 11 wherein:
the measurement report characterizes a session Quality-of-Service Class Indicator (QCI); and
the processing circuitry is further configured to determine the throughput requirement for the session of the user device based on the session QCI.

14. The system of claim 11 wherein:
the measurement report characterizes a user device Buffer Status Report (BSR); and
the processing circuitry is further configured to determine the throughput requirement for the session of the user device based on the user device BSR.

15. The system of claim 11 wherein:
the measurement report characterizes a Signal-To-Interference-Plus-Noise Ratio (SINR) at a location of the user device; and
the processing circuitry is further configured to determine the throughput requirement for the session of the user device based on the SINR at the location of the user device.

16. The system of claim 11 wherein:
the measurement report characterizes a user device transmit power, a session Quality-of-Service Class Indicator (QCI), a user device Buffer Status Report (BSR), and a Signal-To-Interference-Plus-Noise Ratio (SINR) at a location of the user device; and
the processing circuitry is further configured to determine the throughput requirement for the session of the user device based on the user device transmit power, the session QCI, the user device BSR, and the SINR at the location of the user device.

17. The system of claim 11 wherein the processing circuitry is further configured to determine the access node capacity based on an amount of available access node radio resources and an amount of required radio resources to maintain access node priority services.

18. The system of claim 11 wherein:
the network slice that the user device is assigned to comprises a set of available network slice features;
the set of available network slice features comprise one or more of a default service, a maximum latency, a Guaranteed Bit Rate (GBR), a Quality-of-Service (QoS), a dedicated bandwidth, and a priority scheduling; and
the processing circuitry is further configured to select one or more of the default service, the maximum latency, the GBR, the QoS, and the dedicated bandwidth based on the throughput requirement and the access node capacity.

19. The system of claim 11 wherein the processing circuitry is further configured to:
transfer a request to a network controller in a core network to enable the one or more selected network slice features for the session of the user device;
receive a response from the network controller that approves enablement of the one or more selected network slice features; and
transfer Downlink Control Information (DCI) signaling that identifies and directs the user device to enable the one or more selected network slice features; and
enable the one or more selected network slice features for the session of the user device in response to receiving the response from the network controller and transferring the DCI signaling.

20. One or more non-transitory computer readable storage media having program instructions stored thereon, wherein the program instruction, when executed by a computing system, direct the computing system to perform operations, the operations comprising:
receiving a measurement report from a user device that characterizes a user device session requirement and an access node radio condition;
determining a throughput requirement for a session of the user device based on the user device session requirement and the access node radio condition;
selecting one or more network slice features of a network slice that the user device is assigned to based on the throughput requirement and an access node capacity;
enabling the one or more selected network slice features for the session of the user device; and
exchanging user data with the user device via the network slice using the one or more enabled network slice features for the session.
